(19) United States
(12) Patent Application Publication
(10) Pub. No.: US 2014/0310262 A1
(43) Pub. Date: Oct. 16, 2014

(54) MULTIPLE SCHEMA REPOSITORY AND MODULAR DATABASE PROCEDURES

(71) Applicant: Cerinet USA Inc., Lexington, VA (US)

(72) Inventor: Michael A. FEINBERG, Tucson, AZ (US)

(73) Assignee: Cerinet USA Inc., Lexington, VA (US)

(21) Appl. No.: 14/212,644

(22) Filed: Mar. 14, 2014

Related U.S. Application Data
(60) Provisional application No. 61/790,559, filed on Mar. 15, 2013.

(51) Int. Cl. G06F 17/30

(52) U.S. Cl. CPC G06F 17/30312; G06F 17/30424
USPC 707/722; 707/812

(57) ABSTRACT

A method for managing repository items is provided for a system having a multiple schema repository that uses a database for storing data for the repository items and management data. The database is configured to manage multiple schemas. The management data for the repository includes information for defining and locating the repository items. The multiple schemas include classification schemas for supporting different types of repository items and a management schema for the management data. The method includes receiving a file including a repository item and data associated with the repository item, wherein the associated data includes categorizing information for the repository item. The method also includes determining whether the database already includes the repository item. The method further includes, if the repository item is not already in the database, creating a management record for the repository item, and storing the file in a storage area associated with the database.

### CROSS-REFERENCE TO RELATED APPLICATIONS

This application claims the benefit under 35 U.S.C. §119(e) of U.S. Provisional Application Ser. No. 61/790,559, filed on Mar. 15, 2013, which is hereby incorporated by reference herein in its entirety.

### FILED OF THE INVENTION

The present invention is related to systems and methods for managing data in database repository.

### DESCRIPTION OF RELATED ART

The Information Age is a period in human history characterized by the transformation from the traditional industries of the Industrial Revolution to an economy based on information computerization. The onset of the Information Age is associated with a transition spanning from the advent of the personal computer in the late 1970s to the Internet's reaching a critical mass in the early 1990s and the adoption of such technology by the public in the two decades after 1990.

### History

Because the monetization of information management technology predates the Information Age, it is useful to understand the history of the adoption of this technology.

The system of printing and typography that uses movable components to reproduce the elements of a document (usually individual letters or punctuation). The world's first known movable-type system for printing was created in China around 1040 A.D. The acceptance of this movable-type system was limited because it required an enormous amount of labor to manipulate the thousands of ceramic tablets required for scripts based on the Chinese writing system, which has thousands of characters. Johannes Gutenberg's invention of the printing press and independently developed movable type system in Europe around 1450 was widely accepted because of the more limited number of characters needed for European languages. The high quality and relatively low price of the Gutenberg Bible (1455) established the superiority of movable type in Europe, and the use of printing presses spread rapidly. The printing press may be regarded as one of the key factors fostering the Renaissance and, due to its effectiveness, its use spread around the globe.

The increase in the output of books created the demand for a Storage and Retrieval system. The Dewey Decimal Classification (DDC), or Dewey Decimal System, is a proprietary library classification system created by Melvil Dewey in 1876. It has been revised and expanded through 23 major editions, the latest issued in 2011. A library assigns a DDC number that unambiguously locates a particular volume to within a short length of shelving which makes it easy to find any particular book and return it to its proper place on the library shelves.

A key element to the success of the Dewey Decimal Classification was the ability to search by using the card file. With its introduction the DDC standardized the index card used in library card catalogs. Edge-notched cards, or McBee cards, were a manual data storage and manipulation technology invented in 1896 and used for specialized data storage and cataloging applications through much of the 20th century. To record data, the paper stock between a hole and the nearest edge was removed by a special notching tool. The holes were assigned a meaning dependent upon a particular application. Edge-notched cards, however, were not intended to be read by machines. Instead, they were manipulated by passing one or more slim needles through selected holes in a group of cards. As the needles were lifted, the cards that were notched in the hole positions where the needles were inserted would be left behind as the rest of the deck was lifted by the needles. Using two or more needles produced a logical “AND” function. Combining the cards from two different selections produced a logical, “OR.” Quite complex manipulations, including sorting were possible using these techniques.

Herman Hollerith conceived the idea that census data could be represented by holes punched in paper cards and tabulated by machine. The Census of 1890 was the first-ever computerized database—consisting, in essence, of thousands of boxes full of punched cards. Hollerith's enterprise grew into IBM, which dominated the data processing market for most of the 20th century. IBM's fixed-length field, SO-column punch cards became the ubiquitous means of inputting electronic data until the 1970s.

The natural extension of the punch card database to computers is the flat file database which encodes a database model (most commonly a table) as a single file. A spreadsheet may be used to implement a flat file database, which may then be printed or used online for improved search capabilities. In the 1980s, configurable flat-file database computer applications were popular. These programs were designed to make it easy for individuals to design and use their own databases, and were almost on par with word processors and spreadsheets in popularity.

The relational database was first defined in June 1970 by Edgar Codd, of IBM's San Jose Research Laboratory. A relational database is a collection of data items organized as a set of formally described tables from which data can be accessed. Each table has its own primary key which is used to relate information from different tables.

The relational model provides a declarative method for specifying data and queries. Relational database management system (RDBMS) software describes data structures for storing the data and the retrieval procedures for answering queries. In a relational database, the schema defines the tables, fields, relationships, views, indexes, packages, procedures, functions, queues, triggers, types, sequences, materialized views, and other elements. Most implementations of the relational model use the Structured Query Language (SQL) data definition and query language.

A table in an SQL database schema corresponds to:

1. a predicate variable;

2. the contents of a table to a relation;

3. key constraints, other constraints; and

4. SQL queries correspond to predicates.

### Organization of Information

The need to organize information can be broken down into three areas:

1. Storage & retrieval;

2. Search & classification; and

3. Information dissemination.

The Dewey Decimal System is an example of an early storage and retrieval system. The system assisted in locating a book based upon the 100 class divisions each book can be categorized into. The obvious limitation of the system, to locate a book to a shelf, conceals the more important limitation of the DDC: it is an information retrieval system (retrieves a document containing the data) and not a data retrieval system (retrieves the data itself).

An example of an information retrieval query language is Contextual Query Language (CQL), a formal language for representing queries to information retrieval systems such as web indexes, bibliographic catalogs and museum collection information. Today's Internet search engines are examples of information retrieval systems.

Data retrieval involves extracting the wanted data from a database. The two primary forms of the retrieved data are reports and queries. In order to retrieve the desired data, the user presents a set of criteria by a query. Then the Relational Database Management System (RDBMS) selects the queried data from the database. The retrieved data may be stored in a file, printed, or viewed on the screen. A query language, such as Structured Query Language (SQL), is used to prepare the queries. SQL is an American National Standards Institute (ANSI) standardized query language developed specifically to write database queries. Each RDBMS may have its own language, but most RDBMSs also support SQL.

Information Lifecycle Management (sometimes abbreviated ILM) refers to a wide-ranging set of strategies for administering storage systems on computing devices. Data classification is an important part of the ILM process that answers the questions regarding the data types that are available, and the location of specific data.

Statistically, around 15% of data is structured data. This is data accessible only through the Application Programming Interface (API) of a Database Management System (DBMS). To ensure adequate quality standards, the classification process must be monitored by subject matter experts.

All other data that cannot be categorized as structured is around 85%. This is data that has no physical interconnectivity. The data is usually stored in computer files (e.g., documents, pictures, multimedia files). Typically a single relatively simple process of data classification is applied using the following criteria:
1. Geographical: i.e., according to area (e.g., the rice production of a state or country.
2. Chronological: i.e., according to time (e.g., sale of last 3 months).
3. Qualitative: i.e., according to distinct categories, (e.g., population on the basis of poor
and rich).
4. Quantitative: i.e., according to magnitude: a) discrete, and b) continuous.
5. Content criteria: involving the usage of advanced content classification algorithms that evaluate unstructured data for classification.

Information dissemination is an activity through which knowledge (i.e., information, skills, or expertise) is exchanged among people, friends, members of a family, a community (e.g., Wikipedia) or an organization.

Knowledge constitutes a valuable intangible asset for creating and sustaining competitive advantages. While technology constitutes only one of the many factors that affect the sharing of knowledge, the other factors such as property and ownership are not addressed here.

### Limitation of Conventional Technology

The Internet represents a large knowledge base of unstructured data. While search engine algorithms function effectively on some textual documents, the ability to search and retrieve media files is dependent upon the categorization of those files. The data categorizing a file is lost when the file is disseminated.

An example illustrating this limitation is the loss of iPhoto data used to retrieve a specific photograph from an iPhoto Repository when the file containing that photograph is disseminated from iPhoto. The iPhoto Repository is a structured data store that uses data manually entered when a media file is imported to retrieve that file later. That data is not included when the media file is exported from the Repository. Also lacking is any mechanism for importing categorizing data when a media file is imported into a different iPhoto Repository.

Searching most Internet resources is limited to the search engine's text search. Although most Internet repositories use RDBMS with sophisticated structured data, searches (queries) using that structured data are limited to a repositories' web page search feature. This is due to five limitations of the current technology:
1. Most Repository databases are limited to access through their web interfaces which function as a thin client. Even if the database is compliant with the Open Database Connectivity (ODBC) standard, accessing the database for queries requires installation of a specific driver.
2. Querying a database requires an explicit understanding of the schema of that database. This is further complicated in that many RDBMS databases are not SQL compliant.
3. Authentication security to control access to ODBC databases is usually limited to the security features of the RDBMS itself which is often inadequate for access from Internet clients, and is not standardized, thereby requiring special access procedures for each Repository.
4. SQL queries can be very inefficient when implemented over slow networks like the Internet. This is particularly true when the query becomes complex (e.g., multiple-stage query).
5. Both ODBC and SQL only make provision for transferring data contained directly in the database. Query results only contain content from database table fields. In current practice the use of the binary large object (BLOB) database data type is discouraged because of severe performance disadvantages. This results in the practical inability to maintain transaction integrity when large amount of binary data is stored internally in a database field (BLOB).

Conventional Internet searches efficiently access data cached by search engines for very large numbers of Internet sites. However, this is a text search of unstructured data. Currently, there exists no process that can query structured data from multiple Internet repositories. This is due primarily to the limitations of querying a single Repository. It is further complicated by the different schemas used.

### SUMMARY OF THE INVENTION

The invention is related to systems and methods for managing repository items. In one embodiment, a method for managing repository items is provided for a system having a multiple schema repository that uses a database for storing data for a plurality of repository items and management data for the repository. The database is configured to store and manage multiple schemas, wherein the management data for the repository includes categorizing information for defining and locating at least one of the plurality of repository items. The multiple schemas include at least one classification schema for supporting corresponding type or types of repository items and a management schema for the management data, and there is a procedure associated with each of the multiple schemas. The method comprises a step of receiving a file including a repository item and data associated with the repository item. The associated data includes categorizing information for the repository item and a procedure for editing the data associated with the repository item. The method also includes a step of determining whether the database already includes the repository item by querying the database using at least a part of the data associated with the repository item. The method further includes, when it is determined that the repository item is not already stored in the database, a step of creating a management record for the repository item and storing the management record in accordance with the management schema. The method also includes a step of storing the file in a storage area that is associated with the database.

In another embodiment, a method for managing repository items is provided for a system having a multiple schema repository that uses a database for storing data for a plurality of repository items and management data for the repository. The database is configured to store and manage multiple schemas, wherein the management data for the repository includes categorizing information for defining and locating at least one of the plurality of repository items. The multiple schemas include at least one classification schema for supporting corresponding type or types of repository items and a management schema for the management data, and there is a procedure associated with each of the multiple schemas. The method comprises a step of receiving a request to export at least one of the plurality of repository items stored in the database. The method also includes steps of generating a file for each requested repository item, wherein the file for the each requested repository item includes the corresponding requested repository item and data associated with the corresponding requested repository item, including schema data, and exporting the file for the each requested repository item.

In another embodiment, a system for managing repository items is provided. The system comprises a file system, a memory and a processor. The file system including at least one disk configured to contain a database and a multiple schema repository. The database is configured to store and manage multiple schemas comprising at least one classification schema for supporting corresponding type or types of repository items. The multiple schema repository is configured to use the database for storing data for a plurality of repository items and management data for the repository. The management data for the repository includes categorizing information for defining and locating at least one of the plurality of repository items. The multiple schemas further include a management schema for the management data. The memory is communicatively coupled to the file system and configured for storing data including at least a part of the data for a plurality of repository items and the management data. The processor is configured to use the data stored in the memory such that the system can (1) receive a request to export at least one of the plurality of repository items stored in the database, (2) generate a file for each requested repository item, and (3) export the file for the each requested repository item. The file for the each requested repository item includes the corresponding requested repository item and data associated with the corresponding requested repository item, including schema data.

In another embodiment, a system for managing repository items is provided. The system comprises a file system, a memory and a processor. The file system including at least one disk configured to contain a database and a multiple schema repository. The database is configured to store and manage multiple schemas comprising at least one classification schema for supporting corresponding type or types of repository items. The multiple schema repository is configured to use the database for storing data for a plurality of repository items and management data for the repository. The management data for the repository includes categorizing information for defining and locating at least one of the plurality of repository items. The multiple schemas further include a management schema for the management data. The memory is communicatively coupled to the file system and configured for storing data including at least a part of the data for a plurality of repository items and the management data. The processor is configured to use the data stored in the memory such that the system can (1) receive a file including a repository item and data associated with the repository item, (2) determine whether the database already includes the repository item by querying the database using at least a part of the data associated with the repository item, (3) when it is determined that the repository item is not already stored in the database, (4) create a management record for the repository item and storing the management record in accordance with the management schema, and (5) storing the file in a storage area associated with the database. The associated data includes categorizing information for the repository item and a procedure for editing the data associated with the repository item.

In another embodiment, a method for querying repositories is provided. The method includes receiving a request for performing a search for at least one repository item, and, if it is determined that the schema information for the data is not already available, sending a schema query to a target repository residing in a remote system for schema information for data related to the at least one repository item. The method also includes receiving from the target repository the requested schema information, and generating a query module based on the schema information received from the target repository. The query module is configured to interact with a database of the target repository that stores the data related to the at least one repository item such that, when executed at the remote system, the query module can gain access to the database and run a query for the at least one repository item. The method further includes sending the query module to the remote system, and receiving a query result sent from the remote system.

In another embodiment, a system for querying repositories is provided. The system includes a memory and a processor. The memory is configured for storing data, and the processor is communicatively coupled to the memory and configured to use the data such that the system can receive a request for performing a search for at least one repository item, and, if it is determined that the schema information for the data is not already available, send a schema query to a first target repository and a second target repository residing in a first remote system and a second remote system, respectively, for schema information for data related to the at least one repository item. The processor is also configured to use the data such that the system can also receive from the first and second target repositories the requested schema information, and generate a data query module based on the schema information received from the target repository. The data query module is configured to interact with a first and second databases of the first and second target repositories that each stores at least a part of the data related to the at least one repository item such that, when executed at the first and second remote systems, the data query module can gain access to the first and second databases and run a query for the at least one repository item. The data query module is further configured such that instances of the data query module running on different remote systems can communicate with one another. The processor is further configured to use the data such that the system can send the data query module to the first and second remote systems, and receive a query result sent from the first and second remote systems by the data query module.

### BRIEF DESCRIPTION OF THE DRAWINGS

FIG. 1 is a block diagram for illustrating multiple schema repositories in accordance with one embodiment of the disclosed subject matter.

FIG. 2 is a block diagram for illustrating server execution of modular database procedures according to one embodiment of the disclosed subject matter.

FIG. 3 is a block diagram for illustrating server execution of modular database procedure with multiple repository processes in accordance with one embodiment of the disclosed subject matter.

### DETAILED DESCRIPTION OF THE PREFERRED EMBODIMENTS

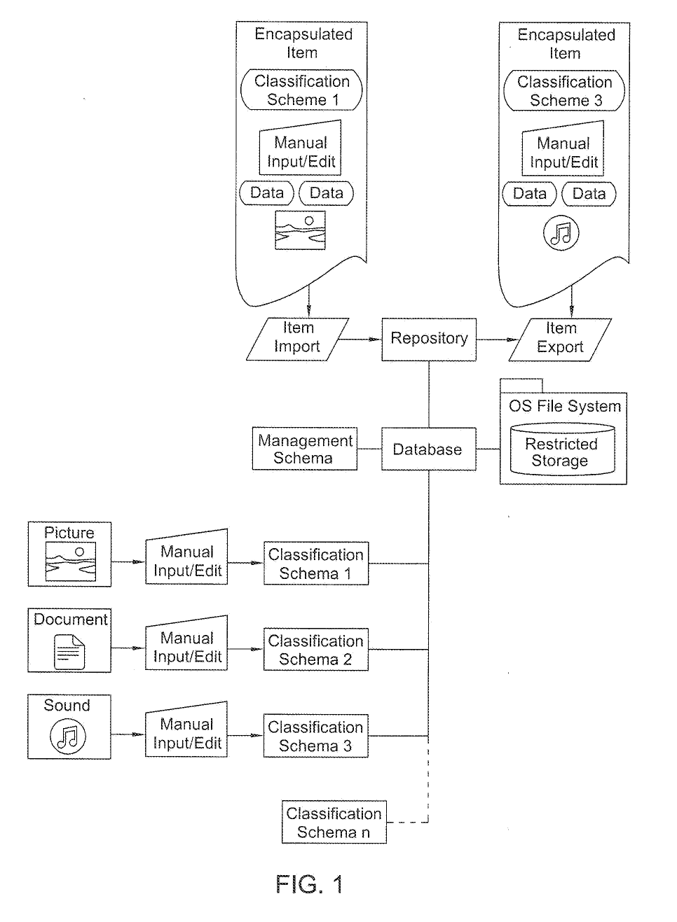

Multiple schema repositories according to example embodiments address issues of Loss of Categorizing Data for Unstructured Resources. FIG. 1 illustrates a multiple schema repository in accordance with one embodiment of the disclosed subject matter. A multiple schema repository according to some embodiments uses a relational database to store both management data for the Repository as well as data for Repository items.

When a media file, e.g., a picture, a video or an audio file is moved from its initial Repository, e.g., in iTunes or in iPhoto, to a different Repository, i.e., another iTunes library or iPhoto library, additional data that a user added to the initial Repository for that media file is lost. iPhoto has a simple fixed schema which allows dividing media files into different groups and assigning, for example, a photo in iPhoto, to multiple groups to provide a simple managed restricted store. However, if iPhoto files are sent to another user or device, this limited information for grouping the files is lost. For example, photos may be conventionally grouped based on information that the photograph is a picture of a user's daughter, that it was taken on a specific date, that it was taken at a specific location, and a particular photo may appear in one or more of the groups. As soon as the photo is moved from its iPhoto system and sent to another user, the information is lost. The photograph now must be accessed not through the group information on iPhoto, but through some type of a database where the photo has categorized structured data manually added.

A multiple schema repository according to example embodiments provides for encapsulating additional data in an initial concept media file for transmission to another Repository. A multiple schema repository according to example embodiments is managed by a database that can deal with multiple schemas and is configured to move an object of a Repository, e.g., a photograph, a recording, a video etc., to another Repository with all of the information for that object, e.g., the grouping information. The information may include not only record data for that particular object or item, but also the schema used to locate that item, to define that item, and to define the database.

Furthermore, a multiple schema repository according to example embodiments may provide a procedure for managing the schema of data. That is, Modules which are configured to enter data into a particular table are provided. The additional data is typically negligible in size as compared to the media data itself. For example, compressed jpegs taken with an iPhone are 99% photographic data and 1% additional data. Example embodiments thus provide a database that can support multiple schemas and enables moving an element or an item from one database to another, i.e., one Repository to another, with all the information for that object, e.g., the categorizing (grouping) information.

These items can be:
1. Media files for sound, still images, motion video, etc. These files meet existing industry standards, allowing them to be accessed and edited with existing applications.
2. Computerized documents stored in a single file, or in a group of files, (e.g., an Adobe InDesign package folder containing the basic document as well as supporting images and fonts.).
3. Data capable of being stored in a field or group of fields in a record of a table of a relational database.

When the Repository item is comprised of data that cannot be stored in a field of the relational database, then the item is assigned an item record in the management schema of the Repository that also contains the location of the file or folder containing the item. Said location is within a restricted portion of the operating system file system that is accessed only by the Repository system.

The Repository supports multiple classification schemas and their associated tables and procedures designed to support the retrieval and manipulation of an item and its associated data. For each schema there is an associated manual procedure for importing an item into the Repository and entering or editing the associated data. Different schemas are used to support different types of repository items.

Once an item is imported, it can be referenced in another schema of the Repository by entering data associated with the alternate schema and selecting an existing Repository item. When an item is exported from the Repository it is combined with the data associated with that item. If the file format supports specially defined data (e.g., Portable Network Graphics (PNG) Private Chunks), then the data can be added to the item in a chunk associated with the Repository management schema. In other cases, the data is encapsulated inside a file that also contains the item's file content.

Data added may comprise; 1) the schema data, 2) the individual item's record data, and/or 3) the manual import/editing procedure. For some schemas the item's record data may be comprised of multiple records. Where an item is included in multiple schemas, data for each schema and its associated record data is included.

When an item is imported into the Repository:
1. The type of file is evaluated and the necessary process to separate the schema data, the record data, and the manual import/editing procedure from the item's data is employed.
2. The Repository management database is queried to see if the item's data already exists in the Repository. A variety of processes to achieve this can be implemented depending upon the configuration of the management schema. These processes can include comparing metadata existing as part of the item's data (e.g., time, date and GPS coordinates in a .JPG file.).
3. If not already present in the Repository, a management record is created and the file or folder containing the item's data is moved into the restricted storage.
4. Schema(s) defined in the imported schema data are used to check if they already exist in the Repository database. If necessary, new schemas with their associated import/editing procedure can be added with user approval.
5. Where schema(s) exist in the Repository that were not included in the imported item's associated data, imported data from other encapsulated schema(s) can be used to create appropriate entries in pre-existing Repository schema(s). Software tools provided as part of the Repository management system can be employed to convert data from one schema to another. Minimally the repositories' existing schema manual import procedure is employed to create an appropriate entry.

As shown in FIG. 1, an encapsulated item may be an encapsulated media file and have one or more classification schemas. The encapsulated item may have a file format, e.g., a Portable Network Graphics (PNG) format, that has a provision for non-PNG related data to be added using a provision PNG calls private chunks in the file itself so that instead of encapsulating the PNG file into a wrapper (which can be done), the additional data or information for the file may be stored in one of these chunks. By storing the additional data in the chunks, there is an advantage that there is no file to unwrap. The encapsulated item may be sent to any user or device, even a device which is non-involved with the repositories, and be viewed on a regular PNG viewer because select viewers may ignore the private chunk. The conventional art does not use the private chunk of PNG files for data storage or schema classifications.

A database may have one or more tables. The tables include fields. The fields typically do not include media type data. There is a concept in databases called the BLOB, i.e., a binary large object, which refers to putting a lot of binary data into a field in a database. Databases typically store text data in the fields, so even if the text field is large, it is typically only 100-200 kilobytes of data. There are users who want to store larger amounts of data in the database fields. For example, an entire video, e.g., a YouTube video, in a database field. In practice, this creates performance and backup problems so that the data is typically not put into a field of type BLOB. The data is instead put into a separate location in a restricted area of the server's file system or sometimes a URL location on a webserver and simply referenced by that location in the database, and because the database typically has tools for managing that data, the database and the file system are kept in synchronization.

In some embodiments, the media data or information may be stored in a managed restricted file system or in a BLOB field in the database itself; however, if that media data is sent to another device or user, the additional data or information for the media data is conventionally removed. The conventional art does not provide for sending an encapsulated item that contains not only the binary data but also the data used for indexing the item in a database and the schema.

The classification schema of the encapsulated item is the defined schema of the database that is used on a particular Repository to index the encapsulated item. The encapsulated item, as shown in FIG. 1 (e.g., a picture), further includes boxes marked data that represent two different records from two different tables in the database that reference the particular image. Of course, there may be more or less than two data fields for the encapsulated item. For example, in the case of a genealogical database, the data fields may provide a relationship of the particular picture to two different people, e.g., Uncle Fred and Aunt Martha, both of which are in the picture because pictures can contain multiple items/entities (e.g., people) and thus may have multiple entries in the database all claiming or retrieving the same picture.

The other encapsulated item in FIG. 1 illustrates that when an item is exported from a Repository according to an example embodiment, it is encapsulated with the additional data or information.

FIG. 1 illustrates various examples of manual input of items to be added to a database and editing of items already stored in the database. For a manual input operation, an input item, e.g., a picture just taken by an iPhone, may be stored on a computer and in its file system. To put the picture into a Repository, one or more schemas are selected to store the picture. For example, if the picture is a picture of two birds sitting on a bridge, the manual import procedure for a schema for birds may be used to import the picture, and a database input window may be provided to name the bird, describe more information about the time and location of the picture, etc. The manual import data procedure now takes the picture, e.g., from the desk top of the computer, copies the picture (and possibly renames the picture depending on the indexing system being used) into the restricted storage of the OS file system. The manual input procedure makes an entry in the management schema of the database that indicates that the picture has been stored in restricted storage with the management schema elected for the classification schema record so that the classifications schema can be used to search for that record based on the type of bird, a date, the time, the location, the photographer, etc., and retrieve the file.

The imported items may thus become structured data. The schema for the structured data may be created by someone who is an expert in the type of data. For example, a radiologist may create schemas for x-rays. Schemas may be created for all fields and areas of research, but schemas may also be created by users at home that simply want a better way of organizing their media.

Accordingly, when a user wants to send one of the objects to another user that is using a similarly compliant Repository, the other user imports that item into the other data Repository, and if they are using a similar schema or the same schema, the items are simply added to the database. If the schema received with the new item is new to the other Repository, the user may add that schema to their database and begin to organize their media files, their photographs, their documents using the new schema. Accordingly, all of the additional information including the classification schema and other data is transported with the file to the other Repository. Items or objects already in the database may be edited by the manual edit operation for a new schema. For example, a user may want to change the schema for a media item or add an additional schema and data.

The management schema module thus stores the various management schemas and their relationships, etc. The management schema also supervises the OS file system restricted storage.

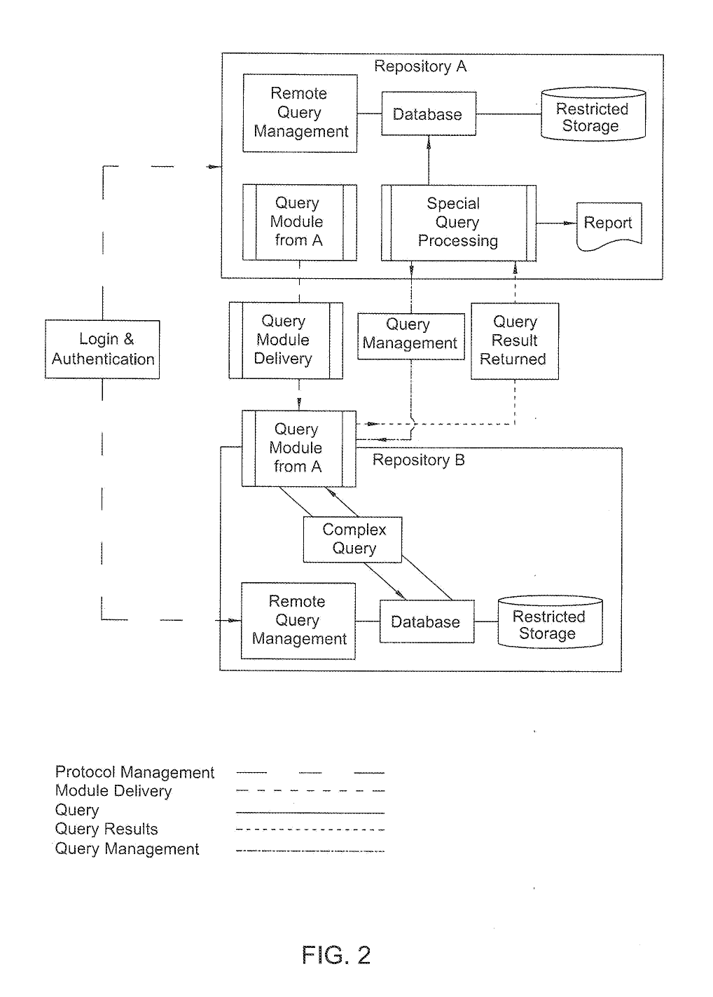

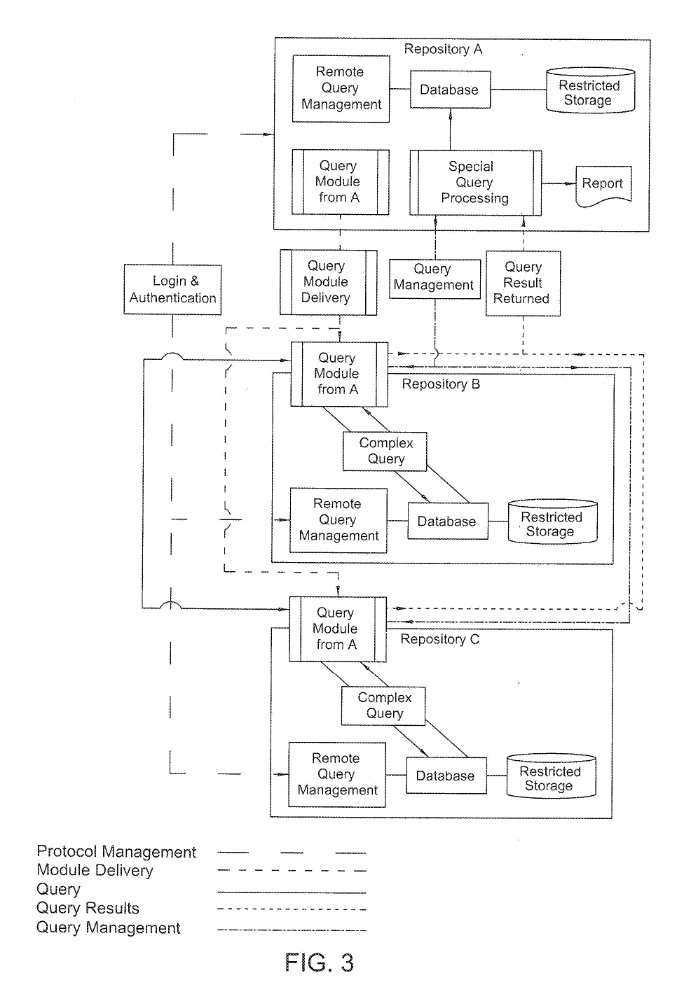

A modular data base system according to example embodiments addresses issues of Inability to Query Repositories and Querying Multiple Repositories. FIG. 2 illustrates server execution of modular database procedures according to an example embodiment. FIG. 3 illustrates server execution of modular database procedures with multiple Repository processes according to an example embodiment. The repositories illustrated in FIGS. 2 and 3 may be restricted storage; however, example embodiments are not limited thereto and the repositories may simply be the database information itself.

For the purposes of this document databases capable of modular procedure processing are referred to as a Repository which comprises an RDBMS database, a restricted storage file system (optional), and software running on the same computer as the RDBMS that is capable of communicating on a network as well as executing queries on the RDBMS either using the RDBMS's API or a standard such as ODBC. This Repository software is also configured to deliver a code module comprising process code that can implement its specific process on another RDBMS Repository operating on a different (remote) computer.

Modular database procedures and systems according to example embodiments are directed to handling queries efficiently. More specifically, example embodiments are directed to avoiding running a query remotely over the network and instead delivering a query module, i.e., a module of code that executes on the server using the database's native API to query the database. The query results are then sent back to the requesting user or Repository. In particular, a complex query is not run on a local machine over the network to the server, the complex query is delivered to the server as a query module and run on the server.

Moreover, if a user wants to run a query on two different databases, the query module is delivered to the two different database servers, and the query module on each database server can interact with each other. For example, a first database running the query module may request that a second database send results that are not on the first database, results from a third database and/or a report of the differences between all three databases.

Any type of procedure supported by the remote Repository's RDBMS API may be created. Typically this is (but is not limited to) an SQL compliant query as illustrated in FIG. 2. The module may already exist on the local Repository, Repository A, or it may be created by Repository software tools. In the case in FIG. 2, the module is labeled Query Module from A, or query module from repository A. The schema used on the remote Repository, Repository B, must be known. Query module creation tools running on Repository A should be capable of querying the appropriate schema from Repository B. If necessary, a special query processing module is created to handle processing of returned query data.

This process is designed to ensure that appropriate permissions exist to allow Repository A to access the information on Repository B. A number of existing authentication processes are acceptable and depend on the degree of security required by Repository B. This is an important consideration because procedure modules may be capable of writing to the remote database if adequate permissions are authenticated.

The simplest form of authentication using a user ID and password may be adequate for read-only access of public information. The additional security provided by public-private keys validated by a certificate authority may be considered a minimum standard. Security can be increased by encrypting all communication, including any results returned. Authentication signing of the procedure module itself is another option to increase security.

A copy of the Query Module is delivered to Repository B. This copy remains on Repository B's computer until it has completed execution. Optionally, it can be cached on Repository B for future use. The module's process is run on Repository B. Typically, this is a complex multi-stage query that takes advantage of the added functionality and faster performance (than implementing each element of the query via ODBC) by accessing the RDBMS using its API. Results of the query are cached on Repository B.

Once the query has completed, the results are returned (4a) to a special query processing module on Repository A that handles outputting the query data in the form of a report, or of merging the query data into Repository A's database. This query data can contain binary data used for media files or other binary data from BLOB database fields or external restricted storage managed file systems. Data for query management (4b) exchanged between the Special Query Processing module on Repository A and the Query Module from repository A running on Repository B can be used to avoid unnecessary transferring of binary data that already exists on Repository A. At this time the authentication protocol negotiates logging off Repository A and dropping the connection. Repository B now deletes or caches the Query Module from repository A.

FIG. 3 illustrates server execution of modular database procedures with multiple Repository processes in accordance with one embodiment of the disclosed subject matter. In some cases, data from additional repositories is needed to complete complex processes involving multiple queries or cross Repository housekeeping (i.e., deleting duplicate data). In the example, after authentication of all three repositories, the Query Module is delivered to both remote repositories: repository B and repository C. During the running of the query, data is exchanged between the Query Modules which can alter the nature of the query. Results can be returned from both remote repositories to Repository A.

As shown in FIGS. 2 and 3, Repository A delivers a query module to Repository B. The query executes on Repository B. The query module from Repository A, which executes on Repository B, receives query management information 4b from the special query processing of Repository A, and the special query processing of Repository A receives query results 4a from the query module from Repository A executing on Repository B. The query management is a special query processing module that can report to the query module from Repository A running on Repository B not to send certain items (e.g., photographs) because those items already exist on Repository A. Particularly because the query module from repository A may be picking up the same item over and over again from the database it is querying, either the query module from repository A executing on Repository B or the special query processing in Repository A stops the sending of redundant copies of the same item.

Data routed between computers is conventionally unstructured. In other words, if a user takes a picture with an iPhone and uses photostream so that the iPhone sends the photograph to iCloud, iCloud conveys the photo to the user's home machine or other connected device. The photograph, however, is unstructured data. There is no way for the user to organize the data in the iPhone. The user must manually move the photos in iPhoto to put photos into simple groups.

FIG. 2 illustrates a Repository A that comprises a database, restricted storage, remote query management, special query processing and a report module. Remote query management is a process that initiates a query and/or receives a request for a query. The remote query management on Repository A enables a user to send a query module from Repository A to Repository B. Repository B may include all or a portion of the elements of Repository A.

The remote query management of Repository B may require a login and authentication process, e.g., a handshake process, before accepting the query module from Repository A. After Repository A positively identifies itself to Repository B, the query module is delivered over the network connection, e.g., the Internet, from Repository A to Repository B. The query module may be created by Repository A in any known programming language code for creating a query for a database. For example, the query module may be based on any programming language that can execute a query directly on the server for the database, e.g., SQL, and uses the database extensions API to talk to the database.

Repository B executes the query module received from Repository A using the most efficient systems for talking to the database on Repository B. That is, the query module queries the database server of Repository B using the native API of the database to achieve the fastest response of the database.

The query module may contain multiple conditionals for running a complicated query. The query module builds a report sends it back to Repository A through a process designed to receive output from the query module, i.e., the report module, and the report module generates a report and/or merges the report into the database of Repository A. The report comprises the results from the query. The query module from Repository A running on Repository B may also provide a status report (not shown) of the current state of the query running on Repository B, e.g., that the query is a certain percentage complete.

The query module and the special query process exchange data related to the query process. In contrast, conventional database languages that are designed to interface directly with the database are not configured to transmit signature information over a network. A query module according to some embodiments provides the ability to open a socket connection between the special query process of Repository A and the query module from repository A running on Repository B.

Repository A may send query modules to a plurality of different repositories at the same time. For example, Repository A may send a query module to Repository B and Repository C at the same time, and in response to the results from Repositories B and C, learn that there is a Repository D that Repository C has identified that was previously unknown to Repository A. Repository A may send a query module to Repository D. As discussed above, the query modules are complex queries that perform logical steps of operations, and based on the data that the modules gather querying the Repository that a particular module executes on, the modules communicate that data back to copies of themselves on other repositories, or send back a report to the Repository that initiated the query process. Moreover, the query modules may modify the databases that they are executing on if the appropriate permissions have been granted.

Although the present invention has been described above with reference to preferred exemplary embodiments, it is not limited thereto but rather can be modified in a wide variety of ways. In particular, the invention can be altered or modified in multifarious ways without departing from the essence of the invention.

What is claimed is:

1. In a system having a multiple schema repository that uses a database for storing data for a plurality of repository items and management data for the repository, wherein the database is configured to store and manage multiple schemas, wherein the management data for the repository includes categorizing information for defining and locating at least one of the plurality of repository items, wherein the multiple schemas include at least one classification schema for supporting corresponding type or types of repository items and a management schema for the management data, and wherein there is a procedure associated with each of the multiple schemas, a method for managing repository items comprises the steps of:
receiving a file including a repository item and data associated with the repository item, wherein the associated data includes categorizing information for the repository item and a procedure for editing the data associated with the repository item;
determining whether the database already includes the repository item by querying the database using at least a part of the data associated with the repository item;
when it is determined that the repository item is not already stored in the database, creating a management record for the repository item and storing the management record in accordance with the management schema; and
storing the file in a storage area that is associated with the database.

2. The method of claim 1, further comprising providing a user interface for allowing a user to import a repository item manually by entering data associated with the repository item.

3. The method of claim 1, further comprising providing a user interface for allowing a user to select a repository item and edit data associated with the selected repository item, wherein the procedure includes a manual procedure, and wherein the user interface invokes the manual procedure associated with one of the at least one classification schema that corresponds to the type of the selected repository schema.

4. The method of claim 1, wherein the categorizing information includes schema data, and wherein it is determined that the repository item is not already stored in the database, further comprising:
determining whether the database already includes a schema that is compatible with a schema associated with the repository item using the schema data included in the categorizing information; and
when it is determined that the database does not already include a compatible schema for the repository item, generating the compatible schema using the schema data.

5. The method of claim 1, further comprising:
receiving a request to export at least one of the plurality of repository items stored in the database;
generating a file for each requested repository item, wherein the file for the each requested repository item includes the corresponding requested repository item and data associated with the corresponding requested repository item, including schema data; and
exporting the file for the each requested repository item.

6. The method of claim 1, further comprising:
receiving a first database query including a query module adapted to query the multiple schema repository;
executing the query module to run the first database query in the database; and
returning query results to at least one target system specified in the first database query.

7. The method of claim 6, wherein the first database query is received from a remote system having a level of access privilege for the database.

8. The method of claim 6, wherein the at least one target system includes at least one of a remote system that sent the first database query and another system to which the remote system sent one of the first database query and a second database query that is related to the first database query.

9. The method of claim 1, wherein the repository item includes a media file.

10. The method of claim 1, wherein the categorizing information includes schema data.

11. A system for managing repository items, comprising:
a file system including at least one disk configured to contain a database and a multiple schema repository, wherein the database is configured to store and manage multiple schemas comprising at least one classification schema for supporting corresponding type or types of repository items, wherein the multiple schema repository is configured to use the database for storing data for a plurality of repository items and management data for the repository, wherein the management data for the repository includes categorizing information for defining and locating at least one of the plurality of repository items, and wherein the multiple schemas further include a management schema for the management data;
a memory communicatively coupled to the file system and configured for storing data including at least a part of the data for a plurality of repository items and the management data; and
a processor configured to use the data stored in the memory such that the system can:
receive a request to export at least one of the plurality of repository items stored in the database;
generate a file for each requested repository item, wherein the file for the each requested repository item includes the corresponding requested repository item and data associated with the corresponding requested repository item, including schema data; and
export the file for the each requested repository item.

12. The system of claim 11, wherein the file system includes a storage area associated with the database, and wherein the processor is further configured to use the data stored in the memory such that the system can:
receive a file including a repository item and data associated with the repository item, wherein the associated data includes categorizing information for the repository item and a procedure for editing the data associated with the repository item;
determining whether the database already includes the repository item by querying the database using at least a part of the data associated with the repository item;
when it is determined that the repository item is not already stored in the database, creating a management record for the repository item and storing the management record in accordance with the management schema; and
storing the file in the storage area associated with the database.

13. The system of claim 11, further comprising a user interface configured to allows a user to import a repository item manually by entering data associated with the repository item.

14. The system of claim 11, further comprising a user interface configured to allow a user to select a repository item and edit data associated with the selected repository item, wherein the user interface invokes a manual procedure associated with one of the at least one classification schema that corresponds to the type of the selected repository schema.

15. The system of claim 11, wherein the at least one classification schema includes at least one of a classification schema for images, a classification schema for documents, a classification schema for sound clips, and a classification schema for video clips.

16. The system of claim 11, wherein the storage area associated with the database includes a restricted storage area.

17. A method for querying repositories, comprising the steps of:
receiving, at a source repository having a source database, a request for performing a search for at least one repository item;
sending a schema query to a target repository residing in a remote system for schema information for data related to the at least one repository item, when it is determined that the schema information for the data is not already available;
receiving from the target repository the requested schema information;
generating a data query module based on the schema information received from the target repository, wherein the data query module is configured to interact with a database of the target repository that stores the data related to the at least one repository item such that, when executed at the remote system, the data query module can gain access to the database and run a query for the at least one repository item;
sending the data query module to the remote system; and
receiving a query result sent from the remote system by the data query module.

18. The method of claim 17, wherein the database is a relational database, wherein the query module is configured to be executed at the remote system using the database's native application program interface (API) for querying the database, and wherein the query for the at least one repository item includes an SQL compliant query, and further including outputting the received query results by at least one of (a) presenting a query report generated based on the query result and (b) merging the query result into a source database.

19. The method of claim 17, further comprising:
sending a query processing module to the remote system to avoid transferring of data that already exists in the source database, wherein the query processing module reports to the data query module not to send redundant data.

20. A system for querying repositories, comprising:
a memory configured for storing data; and
a processor communicatively coupled to the memory and configured to use the data such that the system can:
receive a request for performing a search for at least one repository item;
send a schema query to a first target repository and a second target repository residing in a first remote system and a second remote system, respectively, for schema information for data related to the at least one repository item, when it is determined that the schema information for the data is not already available;
receive from the first and second target repositories the requested schema information;
generate a data query module based on the schema information received from the target repository, wherein the data query module is configured to interact with a first and second databases of the first and second target repositories that each stores at least a part of the data related to the at least one repository item such that, when executed at the first and second remote systems, the data query module can gain access to the first and second databases and run a query for the at least one repository item, and wherein the data query module is further configured such that instances of the data query module running on different remote systems communicate with one another;
send the data query module to the first and second remote systems; and
receive a query result sent from the first and second remote systems by the data query module.
